(19) United States
(12) Patent Application Publication
(10) Pub. No.: US 2016/0124859 A1
(43) Pub. Date: May 5, 2016

(54) COMPUTING SYSTEM WITH TIERED FETCH MECHANISM AND METHOD OF OPERATION THEREOF

(71) Applicant: Samsung Electronics Co., Ltd., Suwon-si (KR)

(72) Inventors: Gerald Zuraski, Austin, TX (US); Vikas Sinha, Austin, TX (US)

(21) Appl. No.: 14/724,057

(22) Filed: May 28, 2015

Related U.S. Application Data
(60) Provisional application No. 62/072,843, filed on Oct. 30, 2014.

(51) Int. Cl. G06F 12/08; G06F 3/06

(52) U.S. Cl. CPC G06F 12/0864; G06F 3/061; G06F 3/064; G06F 3/0673; G06F 12/0897; G06F 2212/6032

(57) ABSTRACT

A computing system includes: a fetch block configured to provide an initial destination and a way prediction associated with the initial destination for accessing a retrieval target; a way block, coupled to the fetch block, configured to determine a way-fetch result based on the way prediction; a parallel circuit, coupled to the fetch block, configured to determine an access destination based on the initial destination in parallel and concurrently with the way block; and an access block, coupled to the way block and the parallel circuit, configured to access the retrieval target based on comparing the access destination and the way-fetch result.

### CROSS-REFERENCE TO RELATED APPLICATION(S)

This application claims the benefit of U.S. Provisional Patent Application Ser. No. 62/072,843 filed Oct. 30, 2014, and the subject matter thereof is incorporated herein by reference thereto.

### TECHNICAL FIELD

An embodiment of the present invention relates generally to a computing system, and more particularly to a system for tiered fetch.

### BACKGROUND

Modern consumer and industrial electronics, such as computing systems, servers, appliances, televisions, cellular phones, automobiles, satellites, and combination devices, are providing increasing levels of functionality to support modern life. While the performance requirements can differ between consumer products and enterprise or commercial products, there is a common need for more performance while reducing power consumption. Research and development in the existing technologies can take a myriad of different directions.

One such direction includes improvements in storing and accessing information. Faster memory or storage capacity is typically more costly, higher in power consumption, or larger in size, than slower memory or storage. As electronic devices become smaller, lighter, and require less power, the amount of faster memory can be limited. Efficiently or effectively using the faster memory or storage can provide the increased levels of performance and functionality.

Thus, a need still remains for a computing system with tiered fetch mechanism for improved processing performance while reducing power consumption through increased efficiency. In view of the ever-increasing commercial competitive pressures, along with growing consumer expectations and the diminishing opportunities for meaningful product differentiation in the marketplace, it is increasingly critical that answers be found to these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### SUMMARY

An embodiment of the present invention provides a system, including: a fetch block configured to provide an initial destination and a way prediction associated with the initial destination for accessing a retrieval target; a way block, coupled to the fetch block, configured to determine a way-fetch result based on the way prediction; a parallel circuit, coupled to the fetch block, configured to determine an access destination based on the initial destination in parallel and concurrently with the way block; and an access block, coupled to the way block and the parallel circuit, configured to access the retrieval target based on comparing the access destination and the way-fetch result.

An embodiment of the present invention provides a system, including: a first buffer block configured to compare a translation-access set with an address for accessing an instruction; a way block, coupled to the first buffer block, configured to determine a way-fetch result using way prediction associated with the instruction based on comparing the translation-access set with the address; and a second buffer block, coupled to the first buffer block, configured to determine a second-buffer result in parallel with the way block for accessing the instruction.

An embodiment of the present invention provides a method including: providing an initial destination and a way prediction associated with the initial destination for accessing a retrieval target; determining a way-fetch result based on the way prediction; determining an access destination based on the initial destination in parallel and concurrently with the way block; and accessing the retrieval target based on comparing the access destination and the way-fetch result.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is an exemplary block diagram of a computing system with tiered fetch mechanism in an embodiment of the present invention.

FIG. 2 is an exemplary block diagram of the computing system.

FIG. 3 is a detailed example block diagram of the computing system.

FIG. 4 is an exemplary operational flowchart of the computing system of FIG. 1.

FIG. 5 is examples of the computing system with the embodiment of the present invention.

FIG. 6 is a flow chart of a method of operation of a computing system in an embodiment of the present invention.

### DETAILED DESCRIPTION

The following embodiments include a first buffer and a second buffer for accessing instruction. The first buffer and the second buffer can be included in a translation buffer for translating an address for accessing the instruction. For a miss event in the first buffer, parallel circuit can fetch instructions based on way prediction simultaneously with accessing the second buffer. Result from the second buffer can be used to verify the result of fetching with the way prediction. The verification of the way-fetch result with access destination in parallel can allow avoidance of additional access latency due to computation of the access destination or due to second buffer access latency.

The following embodiments are described in sufficient detail to enable those skilled in the art to make and use the invention. It is to be understood that other embodiments would be evident based on the present disclosure, and that system, process, architectural, or mechanical changes can be made without departing from the scope of an embodiment of the present invention.

In the following description, numerous specific details are given to provide a thorough understanding of the invention. However, it will be apparent that the invention and various embodiments may be practiced without these specific details. In order to avoid obscuring an embodiment of the present invention, some well-known circuits, system configurations, and process steps are not disclosed in detail.

The drawings showing embodiments of the system are semi-diagrammatic, and not to scale and, particularly, some of the dimensions are for the clarity of presentation and are shown exaggerated in the drawing figures. Similarly, although the views in the drawings for ease of description generally show similar orientations, this depiction in the figures is arbitrary for the most part. Generally, an embodiment can be operated in any orientation.

The term “block” referred to herein can include software, hardware, or a combination thereof in an embodiment of the present invention in accordance with the context in which the term is used. For example, the software can be machine code, firmware, embedded code, and application software. Also for example, the hardware can be circuitry, processor, computer, integrated circuit, integrated circuit cores, a pressure sensor, an inertial sensor, a microelectromechanical system (MEMS), passive devices, or a combination thereof. Further, if a block is written in the apparatus claims section below, the blocks are deemed to include hardware circuitry for the purposes and the scope of apparatus claims.

The blocks in the following description of the embodiments can be coupled to one other as described or as shown. The coupling can be direct or indirect without or with, respectively, intervening between coupled items. The coupling can be physical contact or by communication between items.

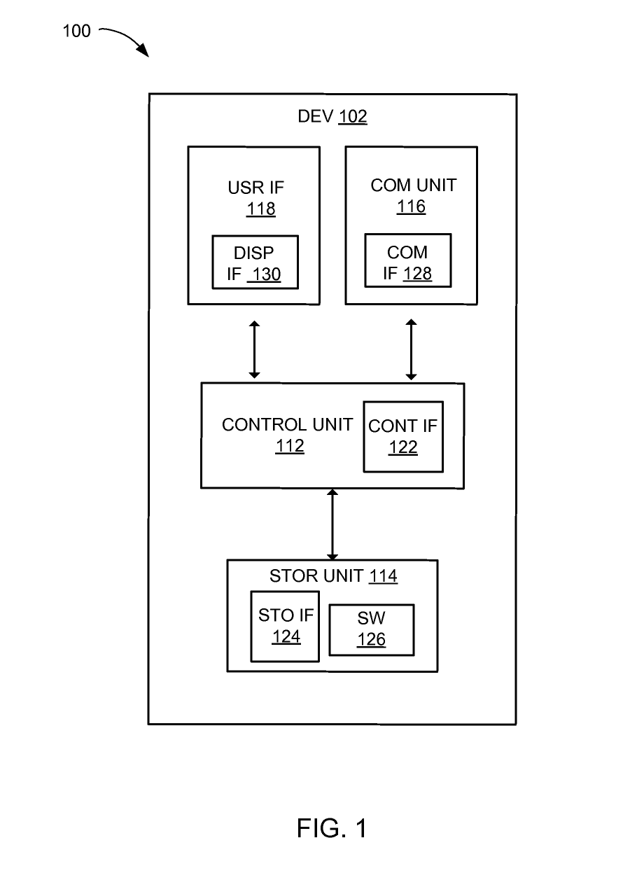

Referring now to FIG. 1, therein is shown an exemplary block diagram of a computing system 100 with tiered fetch mechanism in an embodiment of the present invention. The computing system 100 can include a device 102. The device 102 can include a client device, a server, a display interface, or combination thereof.

The device 102 can include a control unit 112, a storage unit 114, a communication unit 116, and a user interface 118. The control unit 112 can include a control interface 122. The control unit 112 can execute software 126 of the computing system 100.

In an embodiment, the control unit 112 provides the processing capability and functionality to the computing system 100. The control unit 112 can be implemented in a number of different manners. For example, the control unit 112 can be a processor or a portion therein, an application specific integrated circuit (ASIC) an embedded processor, a microprocessor, a central processing unit (CPU), a graphics processing unit (GPU), a hardware control logic, a hardware finite state machine (FSM), a digital signal processor (DSP), a hardware circuit with computing capability, or a combination thereof. As a further example, various embodiments can be implemented on a single integrated circuit, with components on a daughter card or system board within a system casing, or distributed from system to system across various network topologies, or a combination thereof. Examples of network topologies include personal area network (PAN), local area network (LAN), storage area network (SAN), metropolitan area network (MAN), wide area network (WAN), or a combination thereof.

The control interface 122 can be used for communication between the control unit 112 and other functional units in the device 102. The control interface 122 can also be used for communication that is external to the device 102.

The control interface 122 can receive information from the other functional units or from external sources, or can transmit information to the other functional units or to external destinations. The external sources and the external destinations refer to sources and destinations external to the device 102.

The control interface 122 can be implemented in different ways and can include different implementations depending on which functional units or external units are being interfaced with the control interface 122. For example, the control interface 122 can be implemented with a pressure sensor, an inertial sensor, a microelectromechanical system (MEMS), optical circuitry, waveguides, wireless circuitry, wireline circuitry, or a combination thereof.

The storage unit 114 can store the software 126. The storage unit 114 can also store relevant information, such as data, images, programs, sound files, or a combination thereof. The storage unit 114 can be sized to provide additional storage capacity.

The storage unit 114 can be a volatile memory, a nonvolatile memory, an internal memory, an external memory, or a combination thereof. For example, the storage unit 114 can be a nonvolatile storage such as non-volatile random access memory (NVRAM), Flash memory, disk storage, or a volatile storage such as static random access memory (SRAM), dynamic random access memory (DRAM), any memory technology, or combination thereof.

The storage unit 114 can include a storage interface 124. The storage interface 124 can be used for communication with other functional units in the device 102. The storage interface 124 can also be used for communication that is external to the device 102.

The storage interface 124 can receive information from the other functional units or from external sources, or can transmit information to the other functional units or to external destinations. The external sources and the external destinations refer to sources and destinations external to the device 102.

The storage interface 124 can include different implementations depending on which functional units or external units are being interfaced with the storage unit 114. The storage interface 124 can be implemented with technologies and techniques similar to the implementation of the control interface 122.

For illustrative purposes, the storage unit 114 is shown as a single element, although it is understood that the storage unit 114 can be a distribution of storage elements. Also for illustrative purposes, the computing system 100 is shown with the storage unit 114 as a single hierarchy storage system, although it is understood that the computing system 100 can have the storage unit 114 in a different configuration. For example, the storage unit 114 can be formed with different storage technologies forming a memory hierarchal system including different levels of caching, main memory, rotating media, or off-line storage.

The communication unit 116 can enable external communication to and from the device 102. For example, the communication unit 116 can permit the device 102 to communicate with a second device (not shown), an attachment, such as a peripheral device, a communication path (not shown), or combination thereof.

The communication unit 116 can also function as a communication hub allowing the device 102 to function as part of the communication path and not limited to be an end point or terminal unit to the communication path. The communication unit 116 can include active and passive components, such as microelectronics or an antenna, for interaction with the communication path.

The communication unit 116 can include a communication interface 128. The communication interface 128 can be used for communication between the communication unit 116 and other functional units in the device 102. The communication interface 128 can receive information from the other functional units or can transmit information to the other functional units.

The communication interface 128 can include different implementations depending on which functional units are being interfaced with the communication unit 116. The communication interface 128 can be implemented with technologies and techniques similar to the implementation of the control interface 122, the storage interface 124, or combination thereof.

The user interface 118 allows a user (not shown) to interface and interact with the device 102. The user interface 118 can include an input device, an output device, or combination thereof. Examples of the input device of the user interface 118 can include a keypad, a touchpad, soft-keys, a keyboard, a microphone, an infrared sensor for receiving remote signals, other input devices, or any combination thereof to provide data and communication inputs.

The user interface 118 can include a display interface 130. The display interface 130 can include a display, a projector, a video screen, a speaker, or any combination thereof.

The control unit 112 can operate the user interface 118 to display information generated by the computing system 100. The control unit 112 can also execute the software 126 for the other functions of the computing system 100. The control unit 112 can further execute the software 126 for interaction with the communication path via the communication unit 116.

The device 102 can also be optimized for implementing an embodiment of the computing system 100 in a multiple device embodiment. The device 102 can provide additional or higher performance processing power.

For illustrative purposes, the device 102 is shown partitioned with the user interface 118, the storage unit 114, the control unit 112, and the communication unit 116, although it is understood that the device 102 can have any different partitioning. For example, the software 126 can be partitioned differently such that at least some function can be in the control unit 112 and the communication unit 116. Also, the device 102 can include other functional units not shown in for clarity.

The functional units in the device 102 can work individually and independently of the other functional units. For illustrative purposes, the computing system 100 is described by operation of the device 102 although it is understood that the device 102 can operate any of the processes and functions of the computing system 100.

Processes in this application can be hardware implementations, hardware circuitry, or hardware accelerators in the control unit 112. The processes can also be implemented within the device 102 but outside the control unit 112.

Processes in this application can be part of the software 126. These processes can also be stored in the storage unit 114. The control unit 112 can execute these processes for operating the computing system 100.

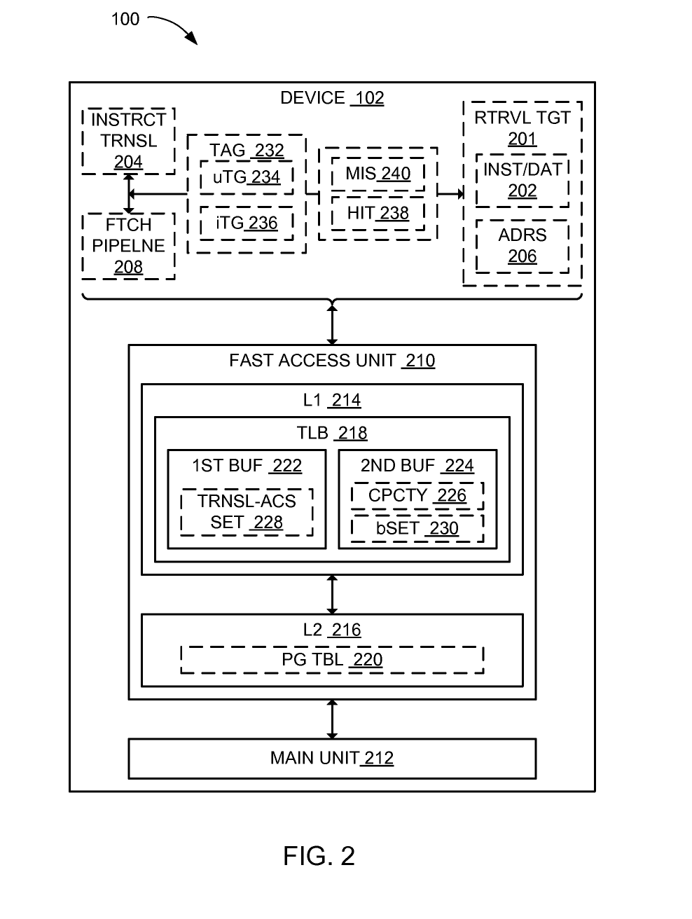

Referring now to FIG. 2, therein is shown an exemplary block diagram of the computing system 100. The block diagram can be an example of a computer architecture or memory hierarchy. The upper portion of FIG. 2 can represent a structure, a process, or related parameters associated with the computer architecture or memory hierarchy. The lower portion of FIG. 2 can represent hardware, function, division, or a combination thereof associated with the computer architecture or memory hierarchy.

For example, the block diagram can represent the control unit 112 of FIG. 1, the control interface 122 of FIG. 1, the storage unit 114 of FIG. 1, the storage interface 124 of FIG. 1, or a combination thereof. As a more specific example, the computing system 100 can be depicted with the block diagram for accessing retrieval target 201. The retrieval target 201 can include an instruction 202 or data.

The computing system 100 can access the retrieval target 201 for executing or according to the software 126 of FIG. 1. For example, the computing system 100 can access the instruction 202 for executing a task, an action, a calculation, or a combination thereof. Also for example, the computing system 100 can retrieve or store the data, including a value or a processing result associated with executing or according to the software 126.

The instruction 202 can include at least one line of executable code for the computing system 100. The instruction 202 can include a command, an operation, a step, or a combination thereof for retrieval or execution by the computing system 100.

The instruction 202 can be included in the software 126. As an example, the instruction 202 can be stored in the storage unit 114, the control unit 112, or a combination thereof. The instruction 202 can also be stored external to the device 102.

The retrieval target 201 can be stored or accessed at a location identified by an address 206 or accessed using the address 206. The computing system 100 can access the retrieval target 201 using an address translation mechanism 204. The computing system 100 can utilize the address translation mechanism 204 to access the storage location identified by the address 206. The address 206 can include a storage location or an access path for the retrieval target 201, including the instruction 202 or the data. The address 206 can include a virtual address, a physical address, or a combination thereof.

The address translation mechanism 204 can include a hardware structure, a method, a process, a step, a sequence thereof, or a combination thereof for identifying physical locations or methods for accessing the retrieval target 201. The address translation mechanism 204 can include translation between virtual address and physical address for accessing the retrieval target 201.

The physical address can include a location in the software 126, a location in secondary storage, tertiary storage, off-line storage, or a combination thereof for the storage unit 114, such as for a hard drive or flash memory. For example, the physical address can include a location in the RAM storing the retrieval target 201. The virtual address can enable reconstruction of the memory or load instructions in controllable or configurable order. The virtual address can allow for out-of-order access for the retrieval target 201, including out-of-order execution of the instructions 202, such as memory or load instructions.

The computing system 100 can utilize or implement a fetch pipeline 208 for accessing the retrieval target 201. The fetch pipeline 208 can include a device, a method, a process, or a combination thereof for performing a set of actions according to a sequence. The fetch pipeline 208 can include components within an instruction cycle. Each instruction 202 can be split into sequence of steps.

In an embodiment, the fetch pipeline 208 can coordinate actions and execution of the instruction 202. The computing system 100 can utilize the fetch pipeline 208 to further execute different instruction 202 concurrently and in parallel. The fetch pipeline 208 can be based on or associated with the virtual address of the instruction 202.

For example, the fetch pipeline 208 can include a sequence of registers, finite state machine, memory, or a combination thereof. Also for example, the fetch pipeline 208 can include a set of steps or actions. The computing system 100 can store information representing an individual action for each register or each step.

As a more specific example, the computing system 100 can store a load instruction, an address, an instance of the instruction 202 or the data, or a combination thereof in each stage. The computing system 100 can execute the steps or actions according to the order within the fetch pipeline 208.

The computing system 100 can access and execute the instruction using a fast-access unit 210, a main unit 212, or a combination thereof. The fast-access unit 210 can include a device or circuitry for providing rapid access to information relative to other memory or devices or circuitry, such as the main unit 212, in the memory hierarchy. For example, the fast-access unit 210 can include cache memory devices or circuitry.

The fast-access unit 210 can include a first level unit 214, a second level unit 216, or a combination thereof. The first level unit 214 and the second level unit 216 can each represent a portion of the fast-access unit 210 capable of storing information, accessing information, or a combination thereof.

The first level unit 214 can include smaller capacity, enhanced capability, or a combination thereof for faster storing or accessing information including the instruction. For example, the first level unit 214 can include Level-1 (L1) cache. Also for example, the second level unit 216 can include Level-2 (L2) cache.

As a more specific example, the first level unit 214 can include a capacity for 32-64 entries and the second level unit 216 can include a capacity greater than 64 entries. Also as a more specific example, the first level unit 214 can be included within an integrated circuit processor and the second level unit 216 can be off chip.

For illustrative purposes, the computing system 100 is shown and described as including the first level unit 214 and the second level unit 216. However, it is understood that the computing system 100 can be different. For example, the computing system 100 can include a third level unit between the second level unit 216 and the main unit 212. Also for example, the computing system 100 can include multiple instances of the first level unit 214, the second level unit 216, the main unit 212, or a combination thereof, multiple cores associated therewith, or a combination thereof.

The main unit 212 can include device or unit with larger capacity than the fast-access unit 210. The main unit 212 can include the device or unit with slower access capability than the fast-access unit 210. For example, the main unit 212 can include RAM, hard-disc, Flash device, remote device, external device, or a combination thereof. The main unit 212 can include the retrieval target 201 stored therein according to the physical address.

The first level unit 214, the second level unit 216, the main unit 212, or a combination thereof can be integral with, included in, or directly accessible by the control unit 112, the control interface 122, the storage unit 114, the storage interface 124, or a combination thereof. For example, the first level unit 214, the second level unit 216, or a combination thereof can be integral with the CPU. Also for example, the second level 214, the main unit 212, or a combination thereof can be physically separate from the CPU, coupled through the memory bus, or a combination thereof.

The fast-access unit 210 or the first level unit 214 therein can include a translation buffer 218. The translation buffer 218 is configured to implement address translation, such as for virtual or logical to physical address. The translation buffer 218 can be utilized by memory management hardware, such as the control unit 112, the control interface 122, the storage unit 114, the storage interface 124, or a combination thereof.

The address translation mechanism 204 can utilize the translation buffer 218 for accessing the retrieval target 201. The translation buffer 218 can include translation look-aside buffer (TLB). The translation buffer 218 can store addresses, page table 220 or a portion therein, or a combination thereof for accessing the retrieval target 201. The translation buffer 218 can include a cache of mappings from the page table 220. For example, the translation buffer 218 for the first level unit 214 can include 32-128 entries.

The page table 220 provides mapping between virtual addresses and physical addresses. The page table 220 can include a data structure for storing mapping between virtual addresses and physical addresses. For example, the page table 220 can include a unit or a grouping of addresses for one or more of the retrieval targets 201, such as the instruction 202 or the data. The virtual addresses can be used by the accessing process from the software 126. The physical addresses can be used by the hardware, such as the fast-access unit 210, the main unit 212, or a combination thereof.

The computing system 100 can include multiple page tables 220 stored in the second level unit 216, the main unit 212, or a combination thereof. The computing system 100 can further include a smaller set of the page tables 220 in the first level unit 214 or the translation buffer 218 therein.

The computing system 100 can include the translation buffer 218 in the first level unit 214. The translation buffer 218 can include a first buffer 222, a second buffer 224, or a combination thereof. The first buffer 222 and the second buffer 224 can be designated as a portion within the translation buffer 218. The first buffer 222 can include a small translation look-aside buffer (sTLB). The second buffer 224 can include a big translation look-aside buffer (bTLB), or a combination thereof.

The first buffer 222 and the second buffer 224 are each a device or a unit for storing address, access information, translation thereof, or a combination thereof. The first buffer 222 can be configured to access or execute faster than the second buffer 224. The second buffer 224 can be larger in capacity 226 than the first buffer 222. For example, the first buffer 222 can include the capacity 226 for 8 page table entries, the second buffer 224 can include the capacity 226 for 64 page table entries, or a combination thereof.

It has been discovered that the first level unit 214 including the first buffer 222 and the second buffer 224 provides increased processor speed and reduction in power consumption. The first buffer 222 can be optimized for speed in accessing the retrieval target 201. The first buffer 222 and the second buffer 224 can further save timing critical logic path. For example, it has been discovered that the first level unit 214 including the first buffer 222 and the second buffer 224 provides at least improvement of ¾ of timing critical logic path in comparison to full address translation and tag compare of about 36 or more bits.

The computing system 100 can include a translation-access set 228, a further set 230, or a combination thereof. The translation-access set 228 is information stored in the first buffer 222. The translation-access set 228 can include a copy of the retrieval target 201, the address 206 corresponding to the retrieval target 201, such as the virtual address, logical address, or the physical address, translation or mapping between the virtual address or the physical address, or a combination thereof.

The translation-access set 228 can be optimized for providing information with highest likelihood of required access. The translation-access set 228 can include one or more specific instances of the page table 220, or one or more portions therein. For example, the translation-access set 228 can include most recently accessed translations, most often accessed translations, a set of translations predetermined by the computing system 100, or a combination thereof.

It has been discovered that the first buffer 222 including the translation-access set 228 including translations with highest likelihood of access provides increased processing speed. The translation-access set 228 including most recently accessed translations, most often accessed translations, a set of translations predetermined by the computing system 100, or a combination thereof can reduce access for the second buffer 224, the second level unit 216, or a combination thereof slower than the first buffer 222.

The further set 230 is information stored in the second buffer 224. The further set 230 can include a copy of the retrieval target 201, the address 206 corresponding to the retrieval target 201, such as the virtual address, logical address, or the physical address, translation or mapping between the virtual address or logical address with the physical address, or a combination thereof.

The further set 230 can include one or more specific instances of the page table 220. The further set 230 can be larger than the translation-access set 228. The translation-access set 228 can be based on the further set 230 or a subset of the entries or information within the further set 230.

The further set 230 can similarly be optimized for providing information with highest likelihood of required access, but for a larger set of possible access or addresses. For example, the further set 230 can include most recently accessed translations, most often accessed translations, a set of translations predetermined by the computing system 100, or a combination thereof.

Each of the entries, such as within the page table 220, the further set 230, the translation-access set 228, or a combination thereof, can include a lookup tag 232, a key tag portion 234 of the lookup tag 232, a further portion 236 of the lookup tag 232, or a combination thereof. The lookup tag 232 can be identification for the corresponding entry in the cache. The lookup tag 232 can include or be based on the address 206 or a portion therein of the retrieval target 201 associated with the entry. The lookup tag 232 can be associated with the virtual address, logical address, the physical address, or a combination thereof.

The key tag portion 234 can include a portion within the lookup tag 232. For example, the key tag portion 234 can include a set of most significant bits (MSB), the least significant bits (LSB), a specific set of bits within the address 206, a hash function applicable thereto, or a combination thereof for indicating a likely location as predetermined by the computing system 100. The key tag portion 234 can be represented as ‘uTag’. The further portion 236 can include the remaining portion of the lookup tag 232 excluding the key tag portion 234. The further portion 236 can be represented as ‘iTag’.

The computing system 100 can use the key tag portion 234 to access the retrieval target 201, verify access for retrieval target 201, verify the address 206, verify address translation, or a combination thereof. It has been discovered that the key tag portion 234 used for accessing the retrieval target 201 provides increased processor speed and efficiency. The key tag portion 234 can reduce the number of bits necessary for accessing the retrieval target 201 or verifying the access for the retrieval target 201, such as in comparison to using entirety of the address 206 or entirety of the lookup tag 232.

The computing system 100 can determine a hit event 238 or a miss event 240 in accessing the retrieval target 201, verifying access for the retrieval target 201, verifying the address 206, verifying address translation, or a combination thereof. The hit event 238 can represent a flag or an indication representing the address 206 or the retrieval target 201 existing or being found in subject unit, buffer, or device. The hit event 238 can be based on searching the first level unit 214, the first buffer 222 or the second buffer 224 therein, the second level unit 216, the main unit 212, or a combination thereof.

For example, the hit event 238 can indicate that the address 206 or a translation for the address 206 is found in the translation buffer 218, the first buffer 222, or a combination thereof. Also for example, the hit event 238 can indicate that the retrieval target 201, the address 206 for the retrieval target 201, translation for the address 206, or a combination thereof can be found in or accessed from the first level unit 214, the first buffer 222 or the second buffer 224 therein, the second level unit 216, the main unit 212, or a combination thereof.

The miss event 240 can represent a flag or an indication representing the address 206, the translation for the address 206, or the retrieval target 201 not found in the searched unit, buffer, device, or a combination thereof. The miss event 240 can be specific to the searched device or unit, such as the first buffer 222, the second buffer 224, or a combination thereof.

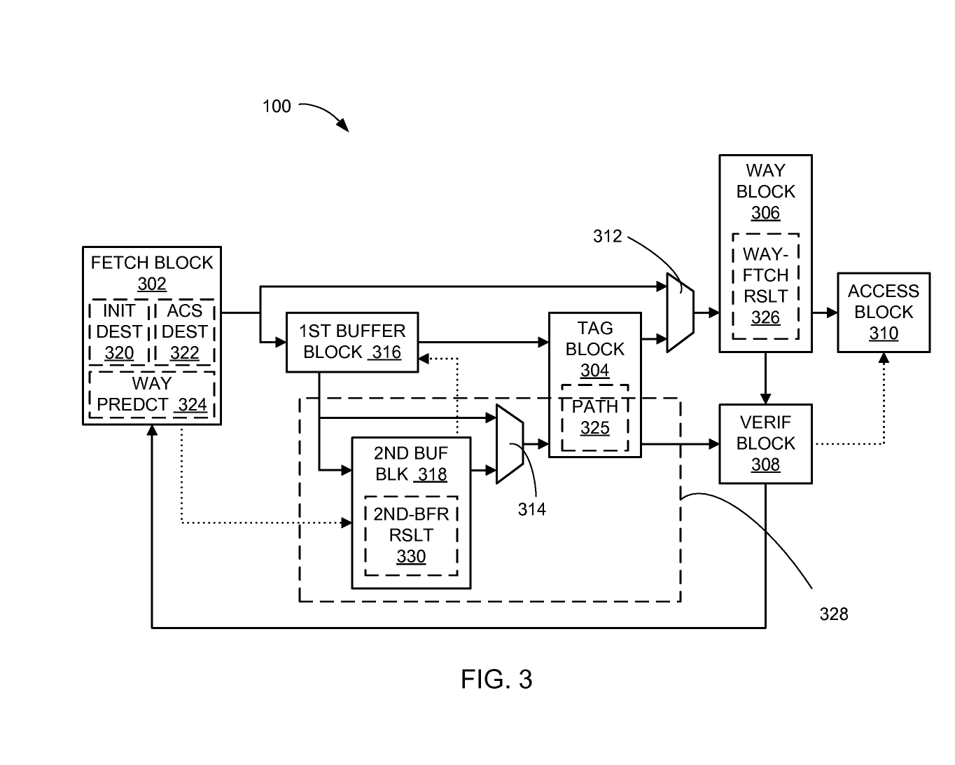

Referring now to FIG. 3, therein is shown a detailed example block diagram of the computing system 100. The computing system 100 can include a fetch block 302, a tag block 304, a way block 306, a verification block 308, an access block 310, a first multiplexer 312, a second multiplexer 314, or a combination thereof. The computing system 100 can further include a first buffer block 316, the second buffer block 318, or a combination thereof.

The fetch block 302 can be coupled to the first buffer block 316, the first multiplexer 312, the verification block 308, the second buffer block 318, or a combination thereof. The first buffer block 316 can be coupled to the tag block 304, the second multiplexer 314, the second buffer block 318, or a combination thereof. The tag block 304 can be coupled to the first multiplexer 312, the second multiplexer 314, the verification block 308, or a combination thereof.

The first multiplexer 312 can be coupled to the way block 306, which can be further coupled to the access block 310, the verification block 308, or a combination thereof. The second multiplexer 314 can be coupled to the second buffer block 318, the first buffer block 316, the tag block 304, or a combination thereof.

The blocks, buffers, units, or a combination thereof can be coupled to each other in a variety of ways. For example, blocks can be coupled by having the input of one block connected to the output of another, such as by using wired or wireless connections, instructional steps, process sequence, or a combination thereof. Also for example, the blocks, buffers, units, or a combination thereof can be coupled either directly with no intervening structure other than connection means between the directly coupled blocks, buffers, units, or a combination thereof, or indirectly with blocks, buffers, units, or a combination thereof other than the connection means between the indirectly coupled blocks, buffers, units, or a combination thereof.

As a more specific example, one or more inputs or outputs of the fetch block 302 can be connected to one or more inputs or outputs of the first buffer block 316, the first multiplexer 312, the second buffer block 318, the verification block 308, or a combination thereof using conductors or operational connections there-between for direct coupling. Also for example, the fetch block 302 can be coupled to the first buffer block 316, the first multiplexer 312, the second buffer block 318, the verification block 308, or a combination thereof indirectly through other units, blocks, buffers, devices, or a combination thereof. The blocks, buffers, units, or a combination thereof for the computing system 100 can be coupled in similar ways as described above.

The fetch block 302 is configured to provide the address 206 of FIG. 2 for determining the retrieval target 201 of FIG. 2. For example, the fetch block 302 can provide the address 206 as a virtual address, a logical address, or a physical address. As a more specific example, the fetch block 302 can provide the address 206 including an initial destination 320 representing the virtual address corresponding to an access destination 322 representing the physical address for the retrieval target 201, such as the instruction 202 of FIG. 2 or the data.

The fetch block 302 can provide the address 206 in various ways. For example, the fetch block 302 can provide the address by computing or identifying the address 206 based on the execution of the software 126 of FIG. 1.

As a more specific example, the fetch block 302 can provide the address 206 according to a program, a task, an application, operating system, or a combination thereof being executed by the device 102 of FIG. 1. Also as a more specific example, the fetch block 302 can provide the address 206 according to a program counter or a program order, the fetch pipeline 208 of FIG. 2, or a combination thereof.

The initial destination 320 can include an index. The index can further distinctly identify each set within the cache. The set and a way can identify an entry within a cache.

The fetch block 302 can further generate a way prediction 324 corresponding to the address 206. The way prediction 324 is information or data estimating or indicating a storage area or segment, a direction, a path, or a combination thereof for accessing the retrieval target 201, including the instruction 202 or the data. The way prediction 324 can be the estimation or the prediction associated with translating the address 206 for accessing the retrieval target 201. The way prediction 324 can be based on set associative cache and indicate a specific location or region for accessing the retrieval target 201 within multiple possible locations or regions.

The fetch block 302 can generate the way prediction 324 for instruction cache way for the address 206. The fetch block 302 can generate the way prediction 324 based on heuristics, methods, processes, or a combination predetermined by the computing system 100.

The fetch block 302 can be implemented in or using the control unit 112 of FIG. 1, the control interface 122 of FIG. 1, the storage unit 114 of FIG. 1, the storage interface 124 of FIG. 1, a portion therein, or a combination thereof. For example, the fetch block 302 can be implemented in or with the CPU, logic unit, memory management unit (MMU), or a combination thereof.

After providing the address 206, the control flow can pass to the first buffer block 316, the first multiplexer 312, or combination thereof. The control flow can pass through a variety of ways. For example, control flow can pass by having processing results of one block passed to another block, such as by passing the address 206, the way prediction 324, or a combination thereof from the fetch block 302 to the first buffer block 316 or the first multiplexer 312.

Also for example, the control flow can pass by storing the processing results at a location known and accessible to the other block, such as by storing the address 206, the way prediction 324, or a combination thereof, at a storage location known and accessible to the first buffer block 316, the first multiplexer 312, or combination thereof. Also for example, the control flow can pass by notifying the other block, such as by using a flag, an interrupt, a status signal, or a combination thereof.

The first buffer block 316 is configured to check the translation-access set 228 of FIG. 2 for translating the address 206 in accessing the retrieval target 201. The first buffer block 316 can search translation-access set 228 for the initial destination 320. The first buffer block 316 can process, control, or manipulate the first buffer 222 of FIG. 2.

The first buffer 222 can be included in the translation buffer 218 of FIG. 2 for implementing the address translation mechanism 204 of FIG. 2. The first buffer 222 can be optimized to include the smaller capacity 226 of FIG. 2 and faster access for information therein as described above.

The first buffer block 316 can be implemented in or with the control unit 112, the control interface 122, the storage unit 114, the storage interface 124, the first buffer 222, a portion therein, or a combination thereof can check for the address 206 in the translation-access set 228. For example, the first buffer block 316 can be implemented in or interact with the CPU, the MMU, the first buffer 222, a portion therein, or a combination thereof to check for the virtual address or the initial destination 320, in the first buffer 222, such as the sTLB.

The first buffer block 316 can compare the translation-access set 228 with the address 206 including the initial destination 320 for accessing the retrieval target 201. The first buffer block 316 can determine the hit event 238 of FIG. 2 or the miss event 240 of FIG. 2 based on the comparing the translation-access set 228 with the address 206, or with the initial destination 320.

The first buffer block 316 can determine the hit event 238 when the initial destination 320 is within the translation-access set 228, the first buffer 222, or a combination thereof. When the initial destination 320 is found in the translation-access set 228, the first buffer block 316 can get or retrieve the translated physical memory address, such as the access destination 322, for accessing the retrieval target 201. The first buffer block 316 can determine the miss event 240 when the initial destination 320 is not within the translation-access set 228, the first buffer 222, or a combination thereof.

After checking the translation-access set 228, the control flow can be passed to the tag block 304, the second buffer block 318, the second multiplexer 314, or a combination thereof. The control flow can be passed similarly as described above between the fetch block 302 and the first buffer block 316.

The tag block 304 is configured to search the cache for the address 206. The tag block 304 can search in the cache, such as the fast access unit 210, for the access destination 322 or the physical address provided by the first buffer block 316. The tag block 304 can search in the fast access unit 210 based on the hit event 238 resulting from searching the first buffer 222.

The tag block 304 can determine a path 325 or the way corresponding to the set associative caching scheme for accessing the retrieval target 201 based on the address 206. The path 325 can represent an indication of the way according to the set associative caching scheme for identifying a specific location within a set of possible locations for accessing the retrieval target 201.

The tag block 304 can determine the path 325 for accessing the retrieval target 201 based on the access destination 322 provided from translating the initial destination 320. The tag block 304 can determine the path 325 based on the hit event 238 and subsequent translation resulting from finding the translation for the virtual address in the first buffer 222.

The tag block 304 can further verify using the lookup tag 232 of FIG. 2 or a portion therein. The tag block 304 can verify the way using the lookup tag 232 overall or the key tag portion 234 of FIG. 2. The tag block 304 can verify the way with the key tag portion 234 based on result of comparing the translation-access set 228 with the key tag portion 234.

It has been discovered that the comparison using the key tag portion 234 provides accurate representation of full cache tag address comparison while reducing the number of processed bits and increasing processing speed. It has been discovered that the key tag portion 234 provides increased accuracy when the way prediction 324 is missing for the address 206 or when the way prediction 324 is determined to be incorrect.

The tag block 304 can be implemented in or with the control unit 112, the control interface 122, the storage unit 114, the storage interface 124, the first buffer 222, a portion therein, or a combination thereof. For example, the tag block 304 can be implemented in or interact with the CPU, the MMU, the first buffer 222, a portion therein, or a combination thereof.

After determining the path 325, the control flow can be passed to the first multiplexer 312, the verification block 308, or a combination thereof. The control flow can be passed similarly as described above between the fetch block 302 and the first buffer block 316.

The first multiplexer 312 is configured to select the information for further processing. The first multiplexer 312 can choose between the output of the fetch block 302 or the output of the tag block 304. The first multiplexer 312 can choose based on comparing the translation-access set 228 with the initial destination 320. The first multiplexer 312 can select the way prediction 324 or select the result of comparing with the key tag portion 234 based on the miss event 240 or the hit event 238.

For example, the first multiplexer 312 can select output of the fetch block 302 including the way prediction 324 based on the miss event 240 associated with the first buffer block 316. Also for example, the first multiplexer 312 can select output of the tag block 304 including the path 325 based on the hit event 238. Also for example, the first multiplexer 312 can always select the output of the fetch block 302 including the way prediction 324 when the way prediction 324 is available.

After selecting the information, the control flow can be passed to the way block 306. The control flow can be passed similarly as described above between the fetch block 302 and the first buffer block 316.

The way block 306 is configured to select the way for the set associated caching scheme. The way block 306 can select the way for accessing or reading using the way prediction 324 or the path 325. The way block 306 can process based on the information selected by the first multiplexer 312. The way block 306 can access or read according to the way prediction 324 or the path 325.

The way block 306 can determine a way-fetch result 326 using the way prediction 324, the path 325, or a combination thereof associated with the retrieval target 201. The way block 306 can further determine the way-fetch result 326 based on the first buffer 222 and the key tag portion 234. The way-fetch result 326 is the information or a location according to the way associated with set-associative caching scheme for accessing the retrieval target 201. The way-fetch result 326 can be a processing result or outcome from processing the way prediction 324, the path 325, or a combination thereof.

The way block 306 can be implemented in or with the control unit 112, the control interface 122, the storage unit 114, the storage interface 124, the first buffer 222, a portion therein, or a combination thereof. For example, the way block 306 can be implemented in or interact with the CPU, the logic unit, the MMU, the first buffer 222, a portion therein, or a combination thereof.

After selecting the way, the control flow can be passed to the access block 310, the verification block 308, or a combination thereof. The control flow can be passed similarly as described above between the fetch block 302 and the first buffer block 316.

The access block 310 is configured to access the retrieval target 201, such as the instruction 202 or the data. The access block 310 can access the retrieval target 201 according to the address 206, the access destination 322, the way-fetch result 326, the path 325, or a combination thereof. The access block 310 can access the retrieval target 201 based on the way-fetch result 326 in parallel with determining the access destination 322.

For example, the access block 310 can access the instruction 202 based on the address 206 when the translation is found within the first buffer 222 as represented by the hit event 238. The access block 310 can access with the key tag portion 234, the address 206 including the access destination 322 corresponding to the initial destination 320, or a combination thereof for the hit event 238. The access block 310 can access with the key tag portion 234 when translation is present in sTLB.

Also for example, the access block 310 can access the instruction 202 based on the cache access. The access block 310 can access the instruction 202 already loaded or stored in the cache, such as the first level unit 214 or the second level unit 216.

Also for example, the access block 310 can access based on processing results of the verification block 308. The access block 310 can flush the fetched instructions and restart processing on correct way based on the verification block 308 checking the translation with full instruction cache address tags. When the path 325 or the way prediction 324 is wrong based on analyzing the way-fetch result 326, the access block 310 can flush the fetched instructions or data and restart on correct way. The access block 310 can flush and initiate restart when the way fetch result is found wrong on verification. The access block 310 can initiate a cache miss sequence when the required instructions are missing from cache. Details regarding the verification block 308 are described below.

The access block 310 can be implemented with or in the control unit 112, the control interface 122, the storage unit 114, the storage interface 124, the first buffer 222, a portion therein, or a combination thereof. For example, the access block 310 can be implemented in or interact with the CPU, the logic unit, the MMU, the first buffer 222, a portion therein, or a combination thereof.

The computing system 100 can utilize a parallel circuit 328 for accessing or verifying access for the retrieval target 201. The parallel circuit 328 can represent a process executed simultaneously with the first buffer block 316, the tag block 304, the way block 306, or a combination thereof as described above. The parallel circuit 328 can include the first buffer block 316 or an output thereof, the second buffer block 318, the second multiplexer 314, the tag block 304, the verification block 308, or a combination thereof.

The computing system 100 can execute the parallel circuit 328 simultaneously with the first buffer block 316 regardless of the processing for the first buffer block 316. The computing system 100 can further execute the parallel circuit 328 based on comparing the translation-access set 228 with the address 206 for the first buffer block 316.

It has been discovered that the parallel circuit 328 provides reduced and minimized latency penalty for the miss event 240 in the first buffer 222. The computing system 100 can select the way based on the way prediction 324 as described above based on the miss event 240 for the first buffer 222. The way selection despite the miss event 240 can be simultaneous with the parallel circuit 328, which saves operations and execution cycles for the overall process. The computing system 100 can utilize the parallel circuit 328 to reduce stalls for the processor and eliminate TLB reload penalty

The second buffer block 318 is configured to check the further set 230 of FIG. 2 for the initial destination 320 for accessing the instruction 202. The second buffer block 318 can process, control, or manipulate the second buffer 224 of FIG. 2. The second buffer block 318 can be similar to the first buffer block 316 but utilizing the further set 230 instead of the translation-access set 228.

For example, the second buffer 224 can be included in the translation buffer 218 for implementing the address translation mechanism 204. The second buffer 224 can include larger instances of the capacity 226 in comparison to the first buffer 222 as described above.

Also for example, the second buffer block 318 can compare the further set 230 stored therein with the address 206 for accessing the retrieval target 201. The second buffer block 318 can similarly determine the hit event 238 or the miss event 240 relative to the second buffer 224 based on searching for the address 206 or the initial destination 320 in the further set 230.

The second buffer block 318 can determine a second-buffer result 330 when the initial destination 320 or the translation for the address 206 is within the further set 230, the second buffer 224, or a combination thereof. The second buffer block 318 can determine the second-buffer result 330 as the hit event 238 when the address 206 or the initial destination 320 is found within the further set 230, the second buffer 224, or a combination thereof. The second buffer block 318 can determine the second-buffer result 330 as the miss event 240 otherwise.

The second buffer block 318 can further determine the second-buffer result 330 based on the hit event 238 for the second buffer 224. The second-buffer result 330 can represent the entry including the translation, the access destination 322, the instruction 202, or a combination thereof within the further set 230 corresponding to the initial destination 320.

The second buffer block 318 can compare, determine, or a combination thereof described above in parallel or simultaneously with the first buffer block 316. The second buffer block 318 can further compare, determine, or a combination thereof regardless of the processing result of the first buffer block 316, or based on the processing result of the first buffer block 316.

For example, the second buffer block 318 can compare, determine, or a combination thereof regardless of whether the address 206 is stored in the first buffer 222 or before the searching process for the first buffer 222 is complete. The computing system 100 can utilize the first multiplexer 312, the second multiplexer 314, or a combination thereof to select the data based on the miss event 240 or the hit event 238 relative to the first buffer 222, the second buffer 224, or a combination thereof. Also for example, the second buffer block 318 can compare, determine, or a combination thereof based on the miss event 240 in the first buffer 222.

The second buffer block 318 can be implemented in or interact with the control unit 112, the control interface 122, the storage unit 114, the storage interface 124, the second buffer 224, a portion therein, or a combination thereof. For example, the second buffer block 318 can be implemented in or interact with the CPU, the logic unit, the MMU, the first buffer 222, a portion therein, or a combination thereof to check for the virtual address, such as the initial destination 320, in the second buffer 224, such as the bTLB. Also for example, the second buffer block 318 can be implemented in or interact with the CPU, the logic unit, the MMU, the first buffer 222, a portion therein, or a combination thereof to determine or retrieve the corresponding information.

The second multiplexer 314 is configured to select the information for further processing. The second multiplexer 314 can be similar to the first multiplexer 312. For example, the second multiplexer 314 can choose between the output of the first buffer block 316 or the second buffer block 318, or a combination thereof. Also for example, the second multiplexer 314 can choose based on the hit event 238 or the miss event 240 for the first buffer 222, the second buffer 224, or a combination thereof.

As a more specific example, the computing system 100 can include the first multiplexer 312 always selecting the output of the fetch block 302 including the way prediction 324 when the way prediction 324 is available. The second multiplexer 314 can select the output of the first buffer block 316 when the translation is not found in the first buffer 222 but found in the second buffer 224. The second multiplexer 314 can select the output of the second buffer block 330 when the translation is found in the second buffer 224. The verification block 308 can compare the way-fetch result 326 to the path 325 resulting from the translation found in either the first buffer 222 or the second buffer 224.

Also as a more specific example, the first multiplexer 312 can select the top line shown in FIG. 3 based on the miss event 240 for the first buffer block 316 and the bottom line based on the hit event 238 for the first buffer block 316. The second multiplexer 314 can correspondingly select the corresponding bottom line based on the miss event 240 for the first buffer block 316, the hit event 238 for the second buffer block 318, or a combination thereof. The second multiplexer 314 can select the corresponding top line based on complementary scenario.

The tag block 304 can select the way as described above. The tag block 304 can select the way based on the access destination 322 resulting from translation found in the second buffer 224.

For the parallel circuit 328, the control flow can be passed to the verification block 308. The control flow can be passed similarly as described above between the fetch block 302 and the first buffer block 316.

The verification block 308 is configured to verify the results from separate parallel processes. The verification block 308 can compare the second-buffer result 330 or the access destination 322 resulting from the second buffer block 318 with the way-fetch result 326 for accessing the retrieval target 201. The verification block 308 can further compare the access destination 322 resulting from the first buffer block 316 with the way-fetch result 326 for accessing the retrieval target 201.

The verification block 308 can compare the way-fetch result 326 and the path 325 associated with the access destination 322 for accessing the retrieval target 201. The verification block 308 can use the determined data or the way indicated by the access destination 322 for comparison with the way-fetch result 326. The verification block 308 can initiate a flush process when the way-fetch result 326 is found wrong, including not matching the second-buffer result 330.

The verification block 308 can be implemented with or in the control unit 112, the control interface 122, the storage unit 114, the storage interface 124, the first buffer 222, the second buffer 224, a portion therein, or a combination thereof. For example, the verification block 308 can be implemented in or interact with the CPU, the logic unit, the MMU, the first buffer 222, a portion therein, or a combination thereof.

The access block 310 can access the retrieval target 201 based on the access destination 322 matching the way-fetch result 326. The access block 310 can access when the computing system 100 determines the miss event 240 for the first buffer 222 and the hit event 238 for the second buffer 224 or when the computing system 100 determines the hit event for the first buffer 222. The access block 310, the fetch block 302, or a combination thereof can further implement the flush process, reloading process, table walk process, or a combination thereof.

When the translation is missing from the first buffer 222 and present in the second buffer 224, the translation can be copied back to the first buffer 222. The fetch block 302 can copy only the entries in the translation-access set 228 missing the way prediction 324 or wrong instance of the way prediction 324.

If the translation is missing both in the first buffer 222 and the second buffer 224, then a miss sequence for the translation buffer 218 for the first level unit 214 can be initiated. The fetch pipeline 208 can be stalled and flushed, and the computing system 100 can looked up the required translation in the translation buffer 218 for the second level unit 216 of FIG. 2. In case it is also missing in the second level unit 216, the table walk process can be initiated to translate the virtual address.

In either case, the missing translation is reloaded into the first buffer 222 and the second buffer 224. The fetch block 302 can restart after the translation is available in the translation buffer 218 for the first level unit 214.

It has been discovered that determining the second-buffer result 330 in parallel with the way block 306 processing for the way-fetch result 326 provides reduced overall access time reduced while minimizing penalty for the miss event 240 in the first buffer 222. The computing system 100 can fetch the instruction 202 based on the way prediction 324 or the key tag portion 234 as described above based on the miss event 240 for the first buffer 222. The determining process despite the miss event 240 can be simultaneous with the second-buffer result 330, which saves operations and execution cycles for the overall process. The computing system 100 can use the parallel circuit 328 to reduce stalls for the processor and eliminate TLB reload penalty.

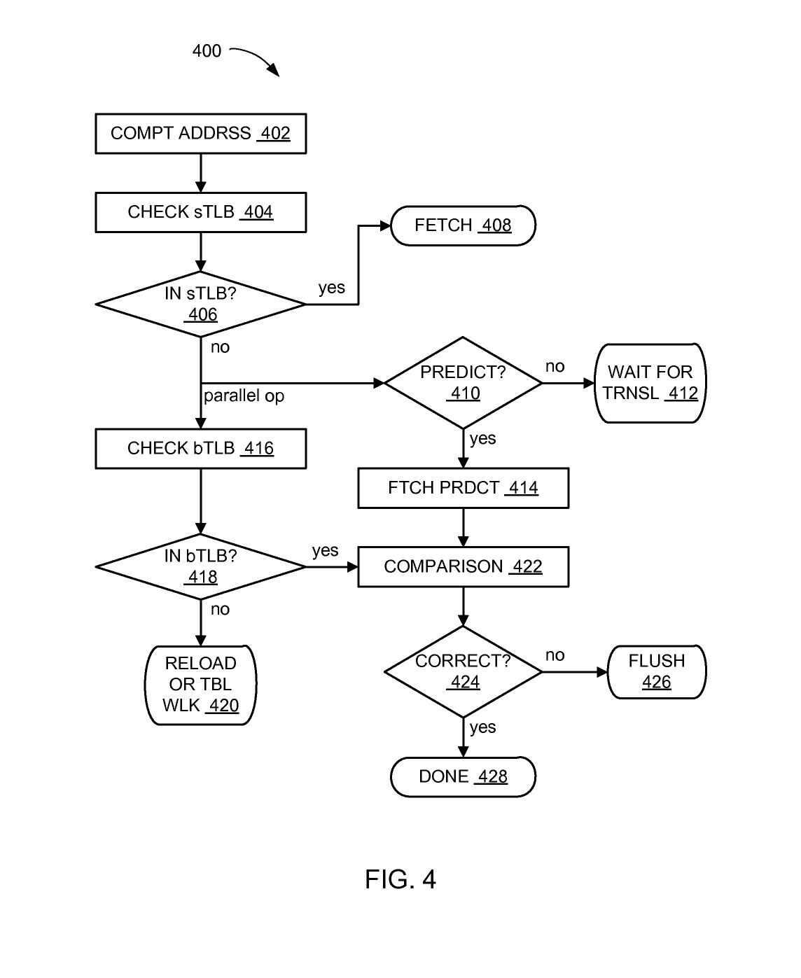

Referring now to FIG. 4, therein is shown an exemplary operational flowchart 400 of the computing system 100 of FIG. 1. The exemplary operational flowchart 400 can describe parallel processing for accessing the instruction 202 of FIG. 2.

The flowchart 400 can include “compute fetch address” in a box 402. The computing system 100 can use the fetch block 302 of FIG. 3 to “compute fetch address” as represented by the box 402. The fetch block 302 can provide the address 206 of FIG. 2, including the initial destination 320 of FIG. 4. For example, the fetch block 302 can provide the virtual address for accessing the instruction 202. Details regarding the fetch block 302 have been described above.

The flowchart 400 can further include “check sTLB” in a box 404 and “in sTLB?” in a box 406. The computing system 100 can use the first buffer block 316 of FIG. 3 to perform “check sTLB” and “in sTLB?”. The first buffer block 316 can search the translation-access set 228 of FIG. 2 for the first buffer 222 of FIG. 2 for the address 206. The first buffer block 316 can determine the hit event 238 of FIG. 2 or the miss event 240 of FIG. 2 for the first buffer 222. Details regarding the first buffer block 316 have been described above.

The flow chart 400 can further include “fetch” in a box 408. The computing system 100 can use the access block 310 of FIG. 3 to perform “fetch” when the address 206 is found in the first buffer 222. The access block 310, the way block 306 of FIG. 3, or a combination thereof can translate the initial destination 320 to determine the access destination 322 of FIG. 3. The access block 310 can access the instruction 202 according to the translation when the translation for the address 206 is included in the first buffer 222. Details regarding the access block 310 and the way block 306 have been described above.

The flow chart 400 can further include “prediction?” in a box 410. The computing system 100 can use the fetch block 302 or the way block 306 of FIG. 3 to perform “prediction?” when the address 206 is not found in the first buffer 222. The way block 306 can check to see if the way prediction 324 of FIG. 3 exists for the address 206. Details regarding the way block 306 have been described above.

The flow chart 400 can further include “wait for translation” in a box 412. The computing system 100 can use the access block 310 to perform “wait for translation”. The access block 310 can wait until translation is provided when the way prediction 324, the key tag portion 234, or a combination thereof is missing, faulty, or a combination thereof. The access block 310 can use the translation, once provided, to access the instruction in such case. Details regarding the access block 310 have been described above.

The flow chart 400 can further include “fetch predicted way from cache” in a box 414. The computing system 100 can use the access block 310 to perform “fetch predicted way from cache”. The way block 306 can generate the way-fetch result 326 of FIG. 3 based on determining according to the way prediction 324. Details regarding the way block 306 have been described above.

The flow chart 400 can further include “check bTLB” in a box 416 and “in bTLB?” in a box 418. The computing system 100 can use or implement the second buffer block 318 of FIG. 3 simultaneously as “prediction?” as represented in the box 410 to perform “check bTLB” and “in bTLB?”.

The second buffer block 318 can search the further set 230 of FIG. 2 in the second buffer 224 of FIG. 2 for the address 206 when the address 206 is not found in the first buffer 222. The second buffer block 318 can provide the second-buffer result 330 of FIG. 3 or the access destination 322 of FIG. 3 when the address 206 is within the second buffer 224. Details regarding the second buffer block 318 have been described above.

The flow chart 400 can further include “reload or table walk” in a box 420 for when the address 206 is not found in both the first buffer 222 and the second buffer 224. The computing system 100 can use or implement the verification block 308 of FIG. 3, the access block 310, the fetch block 302, or a combination thereof to perform “reload or table walk”. The computing system 100 can access the second level unit 216 of FIG. 2, the main unit 212 of FIG. 2, or a combination thereof to reload the page table 220 of FIG. 2 including the address 206 into the first buffer 222, the second buffer 224, or a combination thereof.

The flow chart 400 can further include “comparison” in a box 422 and “correct?” in a box 424. The computing system 100 can use the verification block 308 to perform “comparison” and “correct?”. The verification block 308 can compare the results of the two separate and parallel processing paths. The verification block 308 can compare and verify the way-fetch result 326 and the second-buffer result 330 or the access destination 322. The verification block 308 can compare and verify when the address 206 or a translation thereof is not within the first buffer 222 and is located within the second buffer 224.

The flow chart 400 can further include “flush” in a box 426. The computing system 100 can initiate the flush process when the results of the two separate parallel processes do not match. The computing system 100 can also initiate the flush process when the way fetch result is found to be incorrect. The computing system 100 can use the verification block 308, the access block 310, the fetch block 302, or a combination thereof delete or release one or more entries or processing results associated with the erroneous result.

The flow chart 400 can further include “done” in a box 428. The computing system 100 can use the verified translation, the instruction 202, or a combination thereof for accessing the instruction 202. The computing system 100 can use the access block 310, the verification block 308, the fetch block 302, or a combination thereof to access the instruction 202 when the results of the two separate parallel processes match, such as between the way-fetch result 326 and the second-buffer result 330.

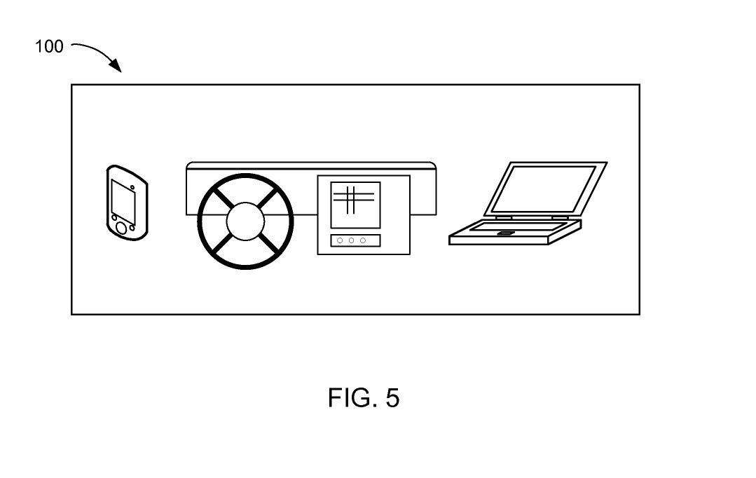

Referring now to FIG. 5, therein is shown examples of the computing system 100 as application examples with the embodiment of the present invention. FIG. 5 depicts various embodiments, as examples, for the computing system 100, such as a smart phone, a dash board of an automobile, and a notebook computer, as example examples with embodiments of the present invention. These application examples illustrate the importance of the various embodiments of the present invention to provide improved processing performance while minimizing power consumption utilizing the first buffer 222 of FIG. 2 and the second buffer 224 of FIG. 2 along with the parallel circuit 328 of FIG. 3.

In an example where an embodiment of the present invention is an integrated circuit processor and the first buffer 222, the second buffer 224, and the parallel circuit 328 are embedded in the processor, then accessing the information or data off chip requires more power than reading the information or data on-chip using the first buffer 222, the second buffer 224, and the parallel circuit 328. Various embodiments of the present invention can reduce overall time required for accessing the instruction 202 of FIG. 2 while reducing penalties from misses in the first buffer 222, for improved performance of the processor.

The computing system 100, such as the smart phone, the dash board, and the notebook computer, can include a one or more of a subsystem (not shown), such as a printed circuit board having various embodiments of the present invention or an electronic assembly having various embodiments of the present invention. The computing system 100 can also be implemented as an adapter card.

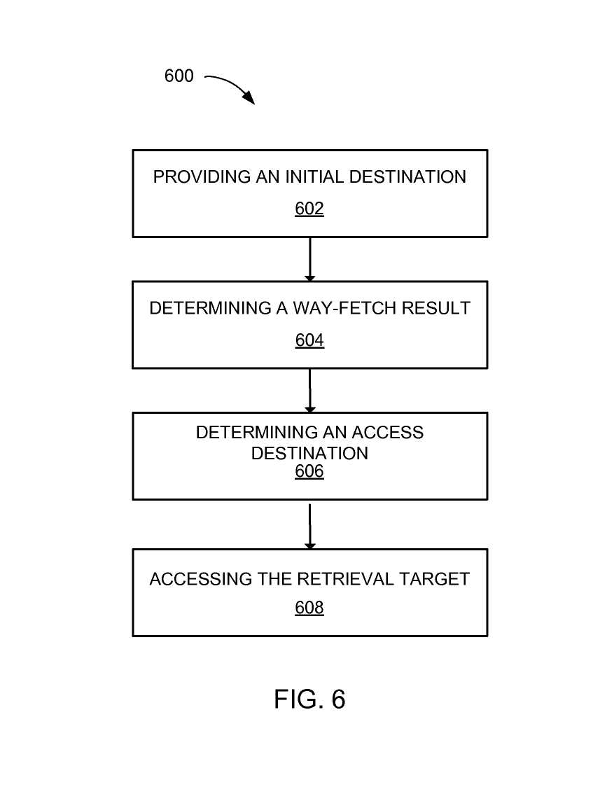

Referring now to FIG. 6, therein is shown a flow chart of a method 600 of operation of a computing system 100 in an embodiment of the present invention. The method 600 includes: providing an initial destination and a way prediction associated with the initial destination for accessing a retrieval target in a block 602; determining a way-fetch result based on the way prediction in a block 604; determining an access destination based on the initial destination in parallel and concurrently with the way block in a block 606; and accessing the retrieval target based on comparing the access destination and the way-fetch result in a block 608.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization. Another important aspect of an embodiment of the present invention is that it valuably supports and services the historical trend of reducing costs, simplifying systems, and increasing performance.

These and other valuable aspects of an embodiment of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters set forth herein or shown in the accompanying drawings are to be interpreted in an illustrative and non-limiting sense.

What is claimed is:

1. A computing system comprising:
a fetch block configured to provide an initial destination and a way prediction associated with the initial destination for accessing a retrieval target;
a way block, coupled to the fetch block, configured to determine a way-fetch result based on the way prediction;
a parallel circuit, coupled to the fetch block, configured to determine an access destination based on the initial destination in parallel and concurrently with the way block; and
an access block, coupled to the way block and the parallel circuit, configured to access the retrieval target based on the access destination and the way-fetch result.

2. The system as claimed in claim 1 further comprising:
a buffer block, coupled to the fetch block, configured to determine the access destination based on searching a buffer for translating the initial destination;
wherein the parallel circuit includes:
a tag block, coupled to the first buffer block, configured to determine a path based on the access destination when the initial destination is in the buffer; and
a verification block, coupled to the tag block, configured to compare the way-fetch result and the path associated with the access destination located in the buffer for accessing the retrieval target.

3. The system as claimed in claim 1 further comprising:
a first buffer block, coupled to the fetch block, configured to determine a miss event based on searching a first buffer for translating the initial destination;
a second buffer block, coupled to the first buffer block, configured to determine the access destination based on searching a second buffer for translating the initial destination based on the miss event for the first buffer block;
wherein the parallel circuit includes:
a tag block, coupled to the second buffer block, configured to determine a path based on the access destination when the initial destination is in the second buffer; and
a verification block, coupled to the tag block, configured to compare the way-fetch result and the path associated with the access destination located in the second buffer for accessing the retrieval target.

4. A computing system comprising:
a first buffer block configured to compare a translation-access set with an address for accessing an instruction;
a way block, coupled to the first buffer block, configured to determine a way-fetch result using way prediction associated with the instruction based on comparing the translation-access set with the address; and
a second buffer block, coupled to the first buffer block, configured to determine a second-buffer result in parallel with the way block for accessing the instruction.

5. The system as claimed in claim 4 further comprising a translation buffer including a first buffer and a second buffer therein corresponding to the first buffer block and the second buffer block, configured to implement instruction translation mechanism.

6. The system as claimed in claim 4 further comprising a verification block, coupled to the second buffer block and the way block, configured to compare the second-buffer result with the way-fetch result for accessing the instruction.

7. The system as claimed in claim 4 further comprising a tag block, coupled to the first buffer block, configured to compare the address or a portion thereof with a key tag portion associated with the instruction.

8. The system as claimed in claim 4 wherein the second buffer block is configured to compare a further set stored therein with the address for accessing the instruction.

9. The system as claimed in claim 4 further comprising:
a main unit configured to store software or a portion therein for accessing the instruction;
a second level unit, coupled to the main unit, configured to store a page table from within the software or the portion therein;
a first level unit including a first buffer and a second buffer corresponding to the first buffer block and the second buffer block, coupled to the second level unit, and configured to implement instruction translation mechanism for accessing the instruction.

10. The system as claimed in claim 9 wherein:
the first buffer block is configured to determine a miss event based on comparing the translation-access set with the address;
the way block is configured to determine the way-fetch result based on the miss event in the first buffer; and
the second buffer block is configured to determine the second-buffer result based on the miss event in the first buffer.

11. The system as claimed in claim 9 further comprising an access block, coupled to the second buffer block and the way block, configured to access the instruction based on the second-buffer result matching the way-fetch result.

12. The system as claimed in claim 9 wherein the way block is configured to determine the way-fetch result based on the address or a portion thereof matching a key tag portion associated with the instruction.

13. The system as claimed in claim 9 further comprising a fetch block, coupled to the first buffer block, configured to copy entries in the further set corresponding to entries in the translation-access set without the way prediction or wrong instance of the way prediction.

14. A method of operation of a computing system comprising:
providing an initial destination and a way prediction associated with the initial destination for accessing a retrieval target;
determining a way-fetch result based on the way prediction;
determining an access destination based on the initial destination in parallel and concurrently with the way block; and
accessing the retrieval target based on the access destination and the way-fetch result.

15. The method as claimed in claim 14 wherein:
determining the access destination includes:
determining the access destination based on searching a buffer for translating the initial destination;
determining a path based on the access destination when the initial destination is in the buffer; and
accessing the retrieval target includes comparing the way-fetch result and the path associated with the access destination located in the buffer for accessing the retrieval target.

16. The method as claimed in claim 14 wherein:
determining the access destination includes:
determining a miss event based on searching a first buffer for translating the initial destination;
determining the access destination based on searching a second buffer for translating the initial destination based on the miss event for the first buffer block;
determining a path based on the access destination when the initial destination is in the second buffer; and
accessing the retrieval target includes comparing the way-fetch result and the path associated with the access destination located in the second buffer for accessing the retrieval target.

17. The method as claimed in claim 14 wherein:
determining the access destination includes comparing a translation-access set in a first buffer with the initial destination for accessing the retrieval target including an instruction;
determining the way-fetch result includes determining the way-fetch result based on comparing the translation-access set with the address; and
determining the access destination further includes determining a second-buffer result in a second buffer in parallel with determining the way-fetch result for accessing the instruction.

18. The method as claimed in claim 17 wherein:
comparing the translation-access set includes comparing the translation-access set in a first buffer within a translation buffer; and
determining the second-buffer result includes determining the second-buffer result from a second buffer within the translation buffer.

19. The method as claimed in claim 17 further comprising comparing the second-buffer result with the way-fetch result for accessing the instruction.

20. The method as claimed in claim 17 wherein determining the way-fetch result includes comparing the address or a portion thereof with a key tag portion associated with the instruction.
